(19) United States
(12) Patent Application Publication
(10) Pub. No.: US 2026/0170330 A1
(43) Pub. Date: Jun. 18, 2026

(54) SYSTEMS, METHODS, AND APPARATUSES FOR UNDETECTED NEURAL NETWORK MONITORING AND CONTROL

(71) Applicant: Beyond AGI LLC, Austin, TX (US)

(72) Inventors: Pavel Jacko, Westbeemster (NL); Marko Lehtimäki, Hyllykallio (FI); Harri S. Sarsa, Berlin (DE)

(21) Appl. No.: 19/420,765

(22) Filed: Dec. 16, 2025

Related U.S. Application Data
(60) Provisional application No. 63/734,207, filed on Dec. 16, 2024.

(51) Int. Cl. G06N 3/08; G06N 3/04

(52) U.S. Cl. CPC G06N 3/08; G06N 3/04

(57) ABSTRACT

The present disclosure sets forth systems, apparatuses, and methods that provide undetected monitoring and control of a neural network. The systems, apparatuses, and methods deploy one or more hooks to access information exchanged between one or more nodes via one or more connections of a neural network during construction of that neural network, capture, via the one or more hooks, information output by a first node of the neural network for receipt by a second node of the neural network, mirror, based on adjustments to the captured information, the one or more nodes of the neural network to form one or more shadow nodes, and select for execution a first shadow node or a first node of the neural network to adjust behavior of the neural network.

### CROSS REFERENCE TO RELATED APPLICATIONS

This patent claims priority to and the benefit of U.S. Provisional Patent Application No. 63/734,207, filed on Dec. 16, 2024, entitled “System for Real-Time Monitoring and Control of Neural Networks via Signal Interception and Adjustment (Neurojack).” U.S. Provisional Patent Application No. 63/734,207 is hereby incorporated herein by reference in its entirety.

### FIELD OF THE DISCLOSURE

This disclosure relates generally to systems, methods, and apparatuses for undetected neural network monitoring and control.

### BACKGROUND

Modern networks are progressing toward self-reflective capabilities. In a self-reflective neural network world, current monitoring techniques will be easily detectable.

### BRIEF DESCRIPTION OF THE DRAWINGS

FIG. 1 is a perspective view of an example generative neural network constructed in accordance with teachings of this disclosure.

FIG. 2 is an alternate view of an example generative neural network constructed in accordance with teachings of this disclosure.

FIG. 3 is a block diagram of a monitoring system implemented in a generative neural network like those set forth in FIGS. 1-2 in accordance with teachings of this disclosure.

FIG. 4 is a flowchart illustrating a process for implementing the monitoring system of FIG. 3 in accordance with teachings of this disclosure.

FIG. 5 is a block diagram of a computing device used in accordance with the teachings of this disclosure.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

The present disclosure relates to monitoring and controlling one or more neural networks comprising neurons. These neurons may be generated, adapted, modified, or eliminated dynamically in real time to constantly adapt to ever-changing inputs. Furthermore, these neurons may establish, create, adjust, ignore or block their own connections to other neurons such that the neural network adapts not only by the number of neurons, but also by their interconnections. The everchanging number of neurons and the connections therebetween establishes the foundation for producing different outputs for a same given input. For example, at a first time, a signal generated based on a first input may pass through the neural network according to a first path. Subsequently at a second time after the neural network neuron configuration has changed, the same signal generated based on the first input may pass through the neural network according to a second, different path. As described further below, the path that the signal takes through the neural network may cause the output produced by the same input to differ, thereby implementing non-deterministic cognition. Additionally, because a neuron may be unaware of the input data (and therefore the input is non-deterministic), the output of a single neuron itself may be non-deterministic.

Typically, neural networks can expand both in terms of execution (e.g., vertical growth) and connections (e.g., horizontal growth). However, due to hardware and other resource limitations, the more execution neurons added to a neural network, the less connections may be added (and vice versa). In the example generative neural networks described herein, such limitations do not exist. Indeed, as described herein, multiple types of execution neurons may be added (e.g., vertical growth) to the neural network as well as new connections (e.g., horizontal growth).

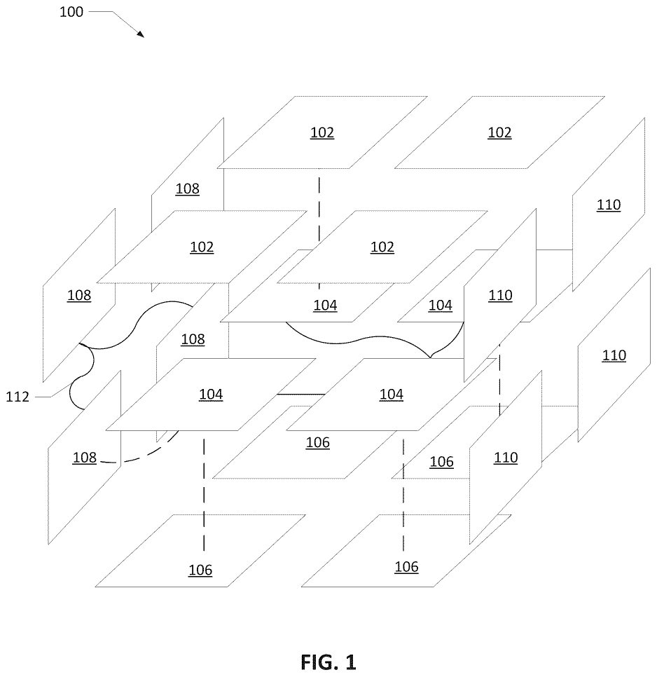

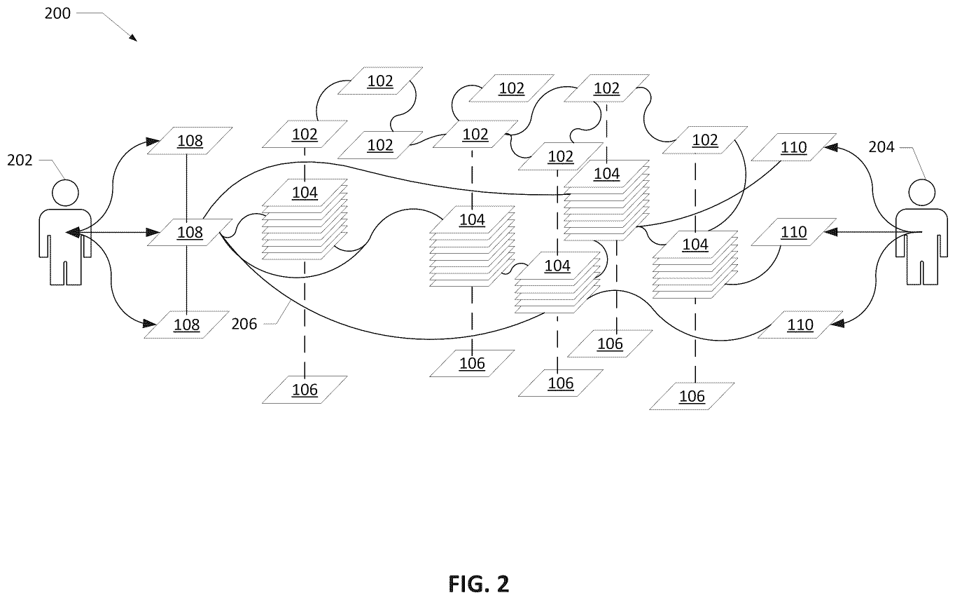

In accordance with the teachings of this disclosure, FIGS. 1-2 set forth perspective views of example generative neural networks 100, 200 comprising a number of neural nodes or instances. The terms “neuron” and “node” are used interchangeably herein to refer to processing units within the network. The exemplary illustrated neural nodes may be implemented via software as modules. In some examples, the exemplary neural nodes may be associated with corresponding hardware or portions of corresponding hardware. In some examples, each neural node may be associated with its own hardware. In some examples, the neural nodes may be implemented on a device, a system, a local area network of devices, a cloud-based network of devices, an Internet based network of devices, or any combination thereof. The generative neural networks 100, 200 may comprise a cognitive node graph runtime 102, an executable node graph runtime 104, a system connect adapter runtime 106, a direct access link runtime 108, and a reality access system runtime 110. Each of the cognitive node graph runtime 102, the executable node graph runtime 104, the system connect adapter runtime 106, the direct access link runtime 108, and the reality access system runtime 110 may communicate via signals via one or more connections 112. As noted above, the one or more connections 112 may be dynamically created, adapted, or blocked, such that the one or more connections 112 are not limited to those illustrated in FIG. 1.

In some examples, the cognitive node graph runtime 102 may create relationships in meanings on the neural nodes of the generative neural networks 100, 200, which may enable the neural nodes to communicate efficiently and effectively. In some examples, the cognitive node graph runtime 102 may adjust (e.g., enrich, reduce, or otherwise update) signals traveling between neurons, which may enable precise and relevant transmission of information. In some examples, the information may be multimodal or otherwise come from disparate types of sources (e.g., text, audio, imagery, video, or any combination thereof). In some such examples, the disparate types of sources may or may not be related. In some examples, the cognitive node graph runtime 102 may provide timely contextualization for large language models (LLMs), which may enable neurons to better understand and respond to changing conditions. In some examples, the cognitive node graph runtime 102 may rely on embeddings. The cognitive node graph runtime 102 may enable long-term memory storage in a compact format.

In some examples, the executable node graph runtime 104 may comprise a number of nodes that act as executable neurons within the generative neural networks 100, 200. In some examples, the nodes may act as neural logic gates, similar to AND, OR, NOT, NAND, NOR, XOR, and XNOR logic gates in digital circuits. In some examples, the nodes may comprise embeddings, API calls, and LLM GUIs (e.g., OllamaChat). In some examples, a node may communicate with an LLM at a synapse activator, during runtime, at an axion signal router, and/or during axion replication. In some examples, the executable node graph runtime 104 communicates with LLMs via the system connect adapter runtime 106. The executable node graph runtime 104 may control the structure of the generative neural networks 100, 200, including the creation, adjustment, or destruction of neurons. In order to create new neurons, the executable node graph runtime 104 may comprise a neural blueprint including a collection of existing neurons to use as a reference or baseline for the creation of the new neurons.

In some examples, the system connect adapter runtime 106 may connect various components of the generative neural networks 100, 200 to LLMs, vector databases, embeddings, static information, vector memory, API calls, deterministic logic, and the like. The example vector databases may comprise NoSQL databases optimized for vector-based data storage and retrieval. The example embeddings may comprise vector representations of words, phrases, and other entities used in natural language processing (NLP). The example static information may comprise fixed values or constants that are generally unchanging. The example vector memory may store and enable retrieval of the vector-based data. The example deterministic logic may comprise pre-defined logic rules or functions that may govern the behavior of the system connect adapter runtime 106.

In some examples, the direct access link runtime 108 may emulate, monitor, and control the one or more neurons or connections. In some examples, the direct access link runtime 108 may monitor and control the one or more neurons or connections via one or more hooks 206. In some examples, the direct access link runtime 108 may provide instantaneous feedback on the state, behavior, and performance of neural nodes. The direct access link runtime 108 may provide bi-directional flow between nodes and an operator 202 (e.g., network administrator, runtime, or program) for real-time observation and modifications for experimentation and analysis.

In some examples, the reality access system runtime 110 may connect one or more neurons to the physical world via one or more interfaces. For example, the reality access system runtime 110 may interface with one or more sensors, input devices, and/or output devices. The reality access system runtime 110 may interface with one or more image sensors (e.g., cameras), audio sensors (e.g., microphones), contact sensors (e.g., haptic feedback), or the like. In some examples, the reality access system runtime 110 may interface with external reality hardware hosts 204 (FIG. 2) such as robots, security systems, appliances, mobile phones, computer networks, autonomous vehicles, and the like. In some examples, portions of the generative neural networks 100, 200 may be offloaded onto the external reality host. In some such examples, a subset of neural nodes of the generative neural networks 100, 200 may be replicated onto the external reality host. In some such examples, the subset of neural nodes may operate in parallel with corresponding neural nodes of the generative neural networks 100, 200.

In operation, the direct access link runtime 108 may invisibly (e.g., without notifying the neural network) intercept signals sent between neurons, inspect system states, perform modifications of the intercepted signals, and/or monitor performance.

Such invisibility provides a technical improvement over traditional systems. For example, the rapid advancement of artificial intelligence has led to the emergence of complex semantic neural networks that transcend traditional neural architectures. While conventional neural networks like transformers operate on mathematical weights and gradients, modern AI systems are evolving into intricate semantic networks where nodes represent diverse computational units from LLM agents and tool interfaces to specialized processing modules and data transformers.

These semantic neural networks may emerge from agentic workflow systems that orchestrate multiple components into sophisticated processing pipelines. Each node may serve as a semantic unit performing specific cognitive functions, whether that is natural language processing, tool utilization, data transformation, or specialized computation. The connections between nodes represent meaningful semantic relationships and information flows, rather than just mathematical weights.

As these systems grow in complexity, they may incorporate millions of heterogeneous nodes working in concert. The nodes may communicate through semantically-rich interfaces, enabling complex reasoning and decision-making to emerge from their collective behavior. This may create a higher-order “semantic neural network” architecture that operates on meaningful relationships rather than pure mathematics.

Such systems face challenges in maintaining cognitive isolation when monitoring or modifying their behavior. Indeed, as these networks become increasingly self-reflective—able to introspect and reason about their own state and topology—they are able to detect monitoring and influence. In contrast, the present systems, methods, and apparatuses provide a monitoring system that operates at a layer that remains completely undetected by the network itself. This enables modifications to the network's perceived reality (e.g., making it process an apple as if it were an orange) without the network detecting the intervention.

In some examples, when signal modifications produce observable anomalies, the neural network may detect side effects of the monitoring system's intervention without detecting the intervention itself. For example, if signals are modified to replace certain information with noise, the neural network may observe unusual patterns in its inputs and attempt to rationalize or understand these anomalies through its normal cognitive processes, analogous to a human experiencing neurological symptoms without awareness of an underlying physical cause. This maintains cognitive isolation while still allowing the network to process its perceived reality authentically.

Traditional monitoring tools, designed for mathematical neural networks, cannot adequately address either the scale or semantic complexity of emerging architectures. Such monitoring tools may not be able to understand, debug, or dynamically adjust the behavior of such complex semantic systems in real-time while maintaining cognitive isolation. Traditional monitoring and debugging tools for neural networks, while effective for conventional architectures, face significant limitations when applied to modern agentic workflow networks.

For example, TensorBoard and similar visualization tools are limited to predefined metrics and have static visualization. Some such systems cannot handle dynamic, runtime modifications. These systems often lack support for semantic relationship monitoring and require pre-configuration during model development.

As another example, PyTorch/TensorFlow hooks operate only at predefined layer boundaries and cannot intercept inter-agent communications. These systems are limited to passive observation without control capabilities and require significant performance overhead for complex networks.

Existing debugging frameworks, including traditional debuggers and profilers, cannot maintain semantic context across agent boundaries. These systems lack understanding of neural network-specific patterns, introduce significant performance penalties when active, and are unable to handle distributed agent architectures.

Current log-based monitoring systems cannot capture real-time signal modifications and are unable to maintain semantic context. Such systems are often limited to surface-level observations and have high storage overhead for complex networks.

Similarly, application performance monitoring (APM) tools focus on system-level metrics rather than neural operations. These tools lack specialized support for AI-specific patterns, cannot handle the scale of modern neural networks, and are unable to modify behavior in real-time.

The limitations of the above mentioned systems and tools become particularly acute in modern agentic frameworks where multiple specialized neural networks operate in concert, complex semantic relationships exist between components, real-time adjustments are necessary for optimal performance, and traditional monitoring boundaries become meaningless.

To that end, the systems, methods, and apparatuses described herein set forth mechanisms for deeply integrated monitoring and manipulation. In some examples, the systems, methods, and apparatuses described herein are designed as part of a neural network during construction of the same, such that the systems, methods, and apparatuses described herein are an integral part of the neural network's architecture. When the systems, methods, and apparatuses described herein are integrated during the initial development of a neural network, the neural network may remain unaware of these systems, methods, and apparatuses during operation. In some examples, the present systems, methods, and apparatus apparatuses may be compatible with multiple neural networks. In some examples the systems, methods, and apparatuses described herein may interface with neural networks running a compatible runtime environment. In some such examples, compatible runtime environments may comprise dynamic code execution, signal interception, state inspection, asynchronous operations, and memory safety. In some examples, these environments may have the ability to modify code execution paths and inject hooks at runtime, support for intercepting and modifying data flow is between components, access internal state and memory of running processes, handle non-blocking operations for monitoring without impacting performance, and provide guaranteed isolation between the monitoring system and the neural networks core operations. Examples of such runtime environments may include V8 (e.g., the JavaScript engine used by Google Chrome), Node.js, Ruby, and Python.

The systems, methods, and apparatuses described herein provide enhanced observability. The systems, methods, and apparatuses described herein provide visibility into the internal workings of neural networks, facilitating better understanding and analysis. The systems, methods, and apparatuses described herein allow for immediate adjustments to network behavior without the need for redeployment, saving time and computational resources. The systems, methods, and apparatuses described herein are capable of handling the high data throughput of complex neural networks with thousands of nodes and rapid signal flows. The systems, methods, and apparatuses described herein offer a standardized framework that can be extended with additional tools, visualizations, and control mechanisms. By design, the systems, methods, and apparatuses described herein operate outside of a neural network's awareness, even in self-reflective architectures. In some examples, the systems, methods, and apparatuses described herein may, when not actively modifying signals, operate in an efficient pass-through mode with minimal overhead. In some examples, the systems, methods, and apparatuses described herein may interface with neural network platforms that support the injection of asynchronous hooks and real-time signal interception. While the systems, methods, and apparatuses described herein may introduce additional processing overhead, they are designed to minimize impact on the neural network's performance through efficient data handling and processing techniques.

In some examples, the systems, methods, and apparatuses described herein ensure that adjustments do not compromise the integrity or security of the neural network, with safeguards to prevent unauthorized access or harmful modifications. The systems, methods, and apparatuses described herein thus provide a significant advancement in the monitoring and control of neural networks. By allowing for real-time observation and adjustment of internal processes, the systems, methods, and apparatuses described herein overcome the limitations of traditional black-box models. The architecture of the systems, methods, and apparatuses described herein—combining deep runtime integration, shadow nodes, and real-time signal interception—enables unprecedented visibility and control over neural network operations.

The systems, methods, and apparatuses described herein provide deep runtime integration without compromising network performance, shadow node architecture for efficient monitoring and control, real-time signal interception and modification capabilities, standardized APIs for third-party integration, and a scalable design supporting complex multi-agent systems.

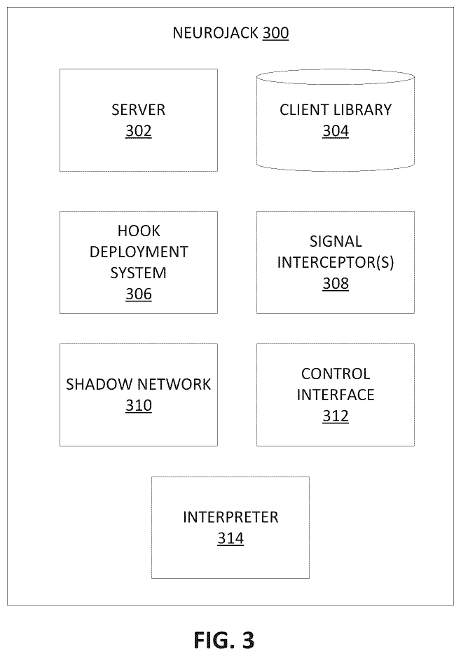

The systems, methods, and apparatuses described herein may be implemented via a two-runtime architecture referred to herein as a neurojack. FIG. 3 illustrates an example neurojack 300. In some examples, the neurojack 300 may be an implementation of the example direct access link runtime 108 illustrated in, and described with reference to, FIGS. 1-2. The example neurojack 300 may comprise a server 302, a client library 304, a hook deployment system 306, one or more signal interceptors 308, a shadow network 310, a control interface 312, and an interpreter 314.

The example server 302 may connect directly to a neural network runtime (e.g., the executable node graph runtime 104). The example server 302 may implement core signal interception and control mechanisms via the one or more signal interceptors 308. The server may manage real time data propagation and buffering, connection management, handshake protocols, and may optimize signal flow for performance.

The example client library 304 may be implemented via any number of programming environments such as, for example, JavaScript, Python, etc. The example client library 304 may provide simplified integration interfaces for third party tools. The client library 304 may simplify complex connection management and handshaking, handle buffering and optimization of signal flows, and enable standardized access to monitoring and control capabilities.

The example hook deployment system 306 may deploy one or more hooks for tapping into the neural network. In some examples, the one or more hooks may be software that enables access to information transmitted between one or more neurons of a neural network. In an example using two neurons, the one or more hooks may enable access to information transmitted from an emitter or output of a first neuron towards an acceptor or input of a second neuron. Likewise, the one or more hooks may enable access to information transmitted from an emitter or output of the second neuron towards an acceptor or input of the first neuron. As neural networks comprise multiple neurons and multiple connections therebetween, the one or more hooks may enable access to information transmitted from any emitter or output of any neuron towards any acceptor or input of any other neuron.

In some examples, the hook deployment system 306 may automatically generate and deploy the one or more hooks. In some examples, the hook deployment system 306 may deploy a hook for one or more connections between the neurons within the neural network. In some examples, the hook deployment system 306 may deploy a hook for each neuron or for each connection between the neurons within the neural network. In some examples the hooks may be lightweight, passive monitoring hooks that operate in read-only mode for observing. In some examples, the one or more hooks may comprise a transformer to change, adjust, or otherwise modify signals from an input neuron and output the changed, adjusted, or otherwise modified signal to the output neuron. In some examples, the hooks may pass signals through immediately without change, adjustment, or modification. In some such examples, the hooks may incur minimum performance overhead and therefore limit its impact on the performance of the neural network. In such examples, the neural network may be completely unaware of the existence of the one or more hooks or their operation because a neuron may only perceive its incoming and outgoing data and connections, and may not perceive the hooks or transformers therebetween.

In some examples, the one or more signal interceptors 308 may operate within or as part of the established hooks between neurons. The one or more signal interceptors 308 may be active control mechanisms that may capture (and/or modify via transformer) signal flow of information. In some examples, the one or more signal interceptors 308 may operate at the lowest possible level of the neural network. Using the previous example of two neurons, the one or more signal interceptors 308 may capture (and/or modify via transformer) signals or information transmitted from the emitter or output of the first neuron and output the captured (or modified/replaced) information to the acceptor or input of the second neuron (or vice versa). In some examples, the one or more interceptors 308 may capture (and/or modify via transformer) signals or information without impacting performance of the neural network. In some examples, the one or more interceptors 308 may capture (and/or modify via transformer) signals or information regardless of the direction of the signal flow (e.g., bi-directional signal flow capture or modification). In some examples, the one or more interceptors 308 may stream captured data to an external system for analysis and visualization.

In some examples, the one or more signal interceptors 308 may pause signal propagation when needed. In some examples, the one or more signal interceptors 308 may support real time signal modification. In some examples, the one or more signal interceptors 308 may be deployed in three modes. The first mode may be an edge runtime filter mode, where direct transformations may occur at node input/output. The second mode may be an external processing mode, capable of full signal hijacking and complex transformations. The third mode may be a node replacement mode, where the one or more signal interceptors 308 may completely substitute a node or its functionality.

The one or more signal interceptors 308 may operate through a sophisticated async/await pattern. In some examples, signals may pass through an asynchronous interceptor function before node runtime execution begins. The one or more signal interceptors 308 may allow signals to pass through immediately (e.g., if no monitoring is to occur). The one or more signal interceptors 308 may await external processing (e.g., if monitoring is active). The one or more signal interceptors 308 may pause execution indefinitely (e.g., for debugging). The one or more signal interceptors 308 may modify signal timing for network-wide behavior adjustment.

In some examples, the one or more signal interceptors 308 enable powerful capabilities such as network-wide execution speed control, temporal manipulation of signal processing, selective pausing and resumption, and dynamic signal modification. For example, introducing a 500 ms delay at each node may effectively “slow down” the entire network's cognitive processing, enabling detailed observation of its behavior.

The shadow network 310 may be a parallel network to the neural network. In some examples, the shadow network 310 may be an additional dimension layer formed based on the visualization of the combination of the one or more hooks. In some such examples, the shadow network 310 may mirror the structure of the main neural network. In some examples, behaviors of the neural network may be adjusted in the shadow network 310 without affecting the behaviors of the neural network. For example, when the one or more interceptors 308 are to make an adjustment or modification to information sent from a neuron, that adjustment may be stored within the shadow network 310 as a shadow node. In some examples, shadow nodes of the shadow network 310 may be lightweight control nodes. In some such examples, the lightweight control nodes may store and execute adjustment formulas locally. In some examples, the lightweight control nodes may enable high performance signal modification without network roundtrips. In some examples, the control nodes may allow for node specific control logic and transformations. In some examples, the shadow nodes of the shadow network 310 may be substituted for the nodes of the neural network. In some such examples, the shadow nodes of the shadow network 310 may be “turned on” (and the original nodes “turned off”) by selecting a shadow node branch. In some examples, the shadow nodes may be “turned off” (and the original nodes “turned off”) by selecting an original node branch. In some examples, the selection between shadow nodes and original nodes may be toggled in real-time, enabling operators to instantly switch between modified behavior (shadow branch active) and original behavior (shadow branch inactive) without restarting or redeploying the neural network.

In some examples, the shadow network 310 may comprise memory for storing metadata about past signals and executions including execution counters, signal history, pattern states, and trigger conditions. In some examples, the metadata may be used by the one or more interceptors 308 and/or transformers for activation, capabilities, or modifications. Because the signal content may be non-deterministic, the shadow node memory enables deterministic modification patterns to be applied over non-deterministic signal content, such as modifying every nth signal regardless of signal content.

In some examples, the shadow network 310 may enable enabling high-performance signal modification without introducing network latency. In some examples, the shadow nodes of the shadow network 310 may maintain input/output schema compatibility with original nodes, supports complete logic replacement while preserving network semantics, enable injection of simplified or modified processing logic, and allow for property modifications and execution hijacking. In some examples, this architecture may supports rapid node execution cycles while maintaining the flexibility to modify behavior as needed.

In some examples, the shadow network 310 may replace complex calculations with simpler alternatives, inject modified logic while maintaining input/output compatibility, completely substitute node functionality during runtime, and maintain network coherence through schema validation.

The control interface 312 may be an interface that enables external systems to configure and adjust network behavior. For example, an external system or network administrator may deploy formulas to nodes of the shadow network, adjust real time parameters, perform mock data configurations and hypotheticals, and or initiate replacements of nodes or connections via the control interface 312.

In some examples, the control interface 312 may provide robust interface mechanisms that enable external systems to interact with both the main neural network and the shadow network 310. These mechanisms may support formula deployment, parameter adjustments, and node replacement operations, while maintaining strict security and performance requirements. The control interface 312 may be language-agnostic, allowing integration with various development environments and tools.

In some examples, the control interface 312 may be a standardized API and schema that serves as a universal interface for external systems to interact with the monitored neural network. In some such examples, the control interface 312 may use a standardized event streaming protocol that third-party systems can subscribe to, receiving real-time updates about node activities, signal flows, and system states. In some examples, the control interface 312 may provide a well-defined schema for controlling network behavior, which may allow external systems to modify signal properties, adjust node parameters, insert or modify processing hooks, configure monitoring rules, and/or deploy custom analysis scripts.

In some examples, the control interface 312 may supports multiple integration patterns including WebSocket connections for real-time data streaming, REST endpoints for configuration and control, message queue interfaces for scalable event processing, and gRPC services for high-performance communication.

In some examples, the control interface 312 may comprise an API event hook system. In some examples, the API event hook system may ensure that any third-party implementation may register for specific types of events or signal patterns, receive real-time notifications when matching events occur, apply transformations or controls through standardized interfaces, and maintain consistency across different neural network architectures

The example interpreter 314 may be a generative AI system that analyzes signals and provides insights and context. In some examples, the interpreter 314 may be a large language model.

The example server 302, the example client library 304, the example hook deployment system 306, the example one or more signal interceptors 308, the example shadow network 310, the example control interface 312, and the example interpreter 314 may integrate directly with a neural network's core execution layer (e.g., the executable node graph runtime 104), initially operating as a lightweight wrapper around runtime execution. In operation, the neurojack 300 may establish basic signal monitoring capabilities at the executor level, collecting and streaming execution data and maintaining minimal overhead through efficient pass-through operations. As the neurojack 300 operates, it may progressively build out additional capabilities such as shadow nodes and transformation functions. In some examples, the shadow nodes may be created dynamically as signal modification points are defined. In some examples, the transformation functions may be added to nodes or connections as needed. The topology of the example shadow network 310 may evolve based on actual monitoring and control requirements. In some examples, this “grow-as-you-go” architecture may ensure that initial integration remains lightweight and performant, system complexity scales with actual usage, resources are allocated only where needed, and the shadow network reflects real operational patterns.

In some examples, a runtime-first approach may allow the neurojack 300 to maintain optimal performance while gradually expanding its monitoring and control capabilities based on actual usage patterns. In some such examples, a runtime environment may support asynchronous operations and hook injection capabilities. The runtime environment may provide mechanisms for signal interception, buffering, and modification while maintaining performance. Additionally, the runtime environment may allow for the creation and management of shadow nodes that can execute transformation logic locally.

To maintain the integrity of the neural network's operation, the neurojack 300 may implement strict cognitive isolation principles. These principles may ensure that monitoring and control mechanisms do not interfere with the network's core cognitive processes, preserving the authenticity of its operations while still enabling observation and controlled modification when necessary.

In some examples, the neurojack 300 may be implemented as a two-layer architecture. The first layer may be an integration layer, where the neurojack 300 may integrate directly with the neural network's core executor, establishing secure channels for signal monitoring and control. This integration layer may handle the low-level aspects of signal interception and modification, ensuring minimal impact on the network's performance while maintaining full observability. The second layer may be the shadow network 310 mirroring the main neural network. As discussed above, the shadow nodes of the shadow network 310 may comprise local transformation logic, adjustment formulas, and control parameters, enabling high-performance signal modification without introducing network latency. The neurojack 300 may be agnostic to specific neural network architectures, provided the underlying system supports asynchronous operations and the injection of hooks.

The example neurojack 300 may be useful in real-time debugging to identify and correct misbehaviors in neural networks without halting operations or redeploying models, behavioral analysis to understand the internal decision-making processes of complex neural networks by observing signal flows and node interactions, dynamic training adjustments to modify training parameters or data inputs on-the-fly to optimize learning outcomes, anomaly detection and correction to automatically detect unusual patterns or errors within the network and applying corrective adjustments in real-time, and virtual reality integration to create virtual reality environments for training and testing, using the neurojack 300 to simulate real-world inputs.

Due to bad actor concerns relating to the ability to capture and manipulate signals and information within a neural network, one or more security measures may be implemented to ensure only authorized entities are allowed access to the control interface 312 and other aspects of the neurojack 300. For example, in an implementation where multiple levels of security clearance as established, the highest level of security clearance may be required to access and interact with the neurojack 300.

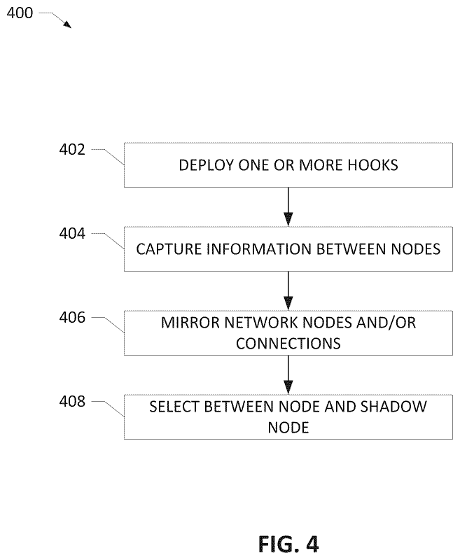

FIG. 4 is a flow chart illustrating an example process 400 for implementing the example neurojack 300. In some examples, the process 400 may begin at step 402 with the hook deployment system 306 deploying one or more hooks to access information exchanged between one or more nodes via one or more connections of a neural network. In some examples, the one or more hooks may be generated and deployed during construction of the neural network. In some examples, the one or more hooks are automatically generated and deployed. At step 404, the one or more signal interceptors 308 may capture, in connection with the one or more hooks, information being exchanged between nodes. For example, information output by a first node of the neural network for receipt by a second node of the neural network may be intercepted or otherwise captured by the one or more signal interceptors 308 prior to receipt by the second node. At step 406, the one or more nodes and/or one or more connections may be mirrored to form a shadow network comprising one or more shadow nodes. In some examples, the one or more shadow nodes may be based on adjustments to the captured information. At step 408, the control interface 312 may select between a first shadow node and a first node of the neural network for execution to adjust behavior of the neural network. In some examples, a network administrator may select between the shadow nodes and nodes of the neural network. In some examples, selecting the first shadow node for execution to may change the captured information output by the first node of the neural network before receipt by the second node of the neural network. In some examples, selecting the first shadow node for execution may pause subsequent execution across the neural network. In some examples, selecting the first node of the neural network for execution may pass through the captured information to the second node of the neural network. In some examples, the control interface 312 may further stream the captured information to an external system.

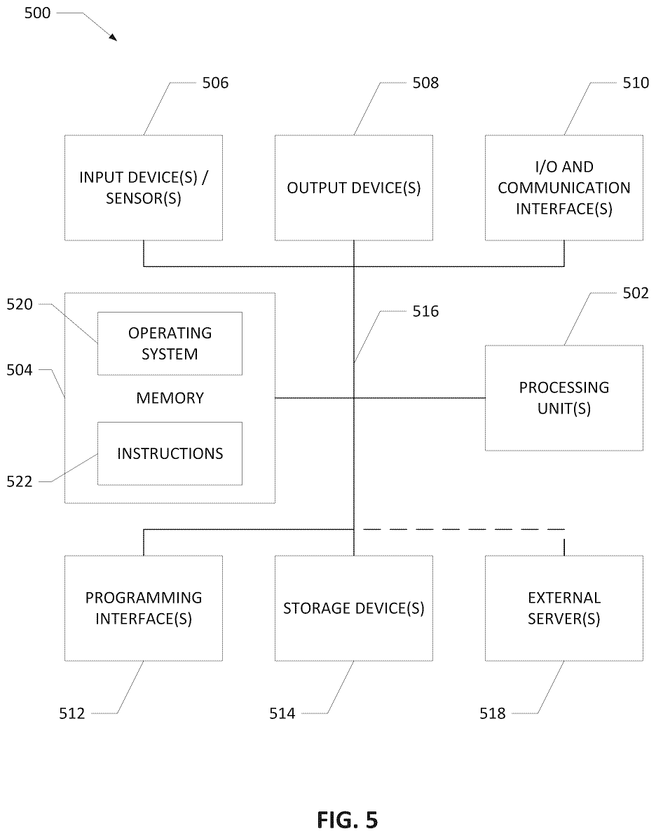

FIG. 5 illustrates an example computing device 500 that may be used in accordance with the teachings described herein. The example computing device 500 may be a computer, a tablet, a mobile device, a server, a workstation, an internet-of-things (IoT) device, a smart appliance, a network node, a hub, a router, a modem, or the like. The example computing device 500 may comprise one or more processing units 502, one or more memory 504, one or more input devices or sensors 506, one or more output devices 508, one or more input/output (I/O) and communication interfaces 510, one or more programming interfaces 512, and one or more storage devices 514. Each of the one or more processing units 502, one or more memory 504, one or more input devices or sensors 506, one or more output devices 508, one or more input/output (I/O) and communication interfaces 510, one or more programming interfaces 512, and one or more storage devices 514 may be interconnected via wired connections such as, for example, a bus 516. Alternatively, each of the one or more processing units 502, one or more memory 504, one or more input devices or sensors 506, one or more output devices 508, one or more input/output (I/O) and communication interfaces 510, one or more programming interfaces 512, and one or more storage devices 514 may be interconnected wirelessly. In some examples, each of the one or more processing units 502, one or more memory 504, one or more input devices or sensors 506, one or more output devices 508, one or more input/output (I/O) and communication interfaces 510, one or more programming interfaces 512, and one or more storage devices 514 may be interconnected via a combination of wired and wireless connections. In some examples, the example computing device 500 may be connected to one or more external servers 518.

In some examples, the processing unit 502 may be a processor such as a central processing unit (CPU), a microprocessor, integrated circuit (IC), an application-specific integrated circuit (ASIC), a Field Programmable Gate Array (FPGA), or a graphical processing unit (GPU). In some examples, the computing device 500 may have one or more processing units 502 for parallel processing. In some such examples, the one or more processing units 502 may be of the same type (e.g., multiple microprocessors). In some examples, the one or more processing units 502 may be of different types (e.g., at least one CPU and at least one GPU).

In some examples, the memory 504 may be a non-transitory computer readable storage medium. In some examples, the memory 504 may include random-access memory, such as DRAM, SRAM, DDR RAM, or other random-access solid-state memory devices. In some examples, the memory 504 may include an operating system 520 and instructions 522.

The operating system 520 may be a traditional operating system that relies on pre-defined rules and structures such as, for example, Microsoft Windows®, Linux, macOS, etc. The operating system 520 may be able to function effectively on a wide range of devices and platforms including smartphones, tablets, desktops, servers, etc. In some examples, the operating system 520 may be decentralized, such that users may share resources and may collaborate without reliance on centralized servers.

The instructions 522 may comprise computer executable instruction sets for implementing the exemplary neurojack 300 and/or process 400 described above with reference to FIGS. 3-4.

In some examples, the one or more input devices or sensors 506 may comprise one or more image/video sensors (e.g., cameras), one or more accelerometers, one or more gyroscopes, one or more thermometers, one or more physiological sensors, one or more microphones, a signal receiver, a haptics engine, a gesture-recognition engine, one or more depth sensors, a keyboard, a numeric pad, a mouse, a touchscreen, a trackpad, or the like.

In some examples, the one or more output devices 508 may comprise one or more displays, one or more speakers, one or more lights (e.g., light emitting diodes), a signal generator, a haptics engine, a printer, or the like.

In some examples, the one or more I/O and communication interfaces 510 may comprise USB, FIREWIRE, THUNDERBOLT, WI-FI, IEEE 802.3x, IEEE 802.11x, IEEE 802.16x, GSM, CDMA, TDMA, GPS, IR, BLUETOOTH, ZIGBEE, SPI, I2C, or a similar type of interface.

In some examples, the one or more programming interfaces 512 may comprise software for implementing one or more physical I/O and communication interfaces, application programming interfaces (APIs) configured for communication with and providing services to databases, software applications, the Internet, or the like.

In some examples, the one or more storage devices 514 may comprise non-volatile memory, such as one or more magnetic disk storage devices, optical disk storage devices, flash memory devices, or other non-volatile solid-state storage devices. In some examples, the one or more storage devices 514 may include one or more databases.

In some examples, the one or more external servers 518 may comprise external processing and storage that may be utilized by the example computing device 500. In some examples, the one or more external servers 518 may be configured similarly to the example computing device 500.

One or more example apparatus, systems, and computer-readable storage mediums are described below.

An example system may comprise a neural network comprising one or more nodes and one or more connections and a monitoring system integrated within the neural network during construction of the neural network.

In some systems, the monitoring system comprises one or more hooks configured to access information being exchanged between the one or more nodes via the one or more connections.

In some systems, the monitoring system comprises one or more interceptors configured to capture information being output by a first node of the neural network for receipt by a second node of the neural network.

In some systems, the monitoring system comprises one or more shadow nodes generated to mirror the one or more nodes and the one or more connections of the neural network, wherein the one or more shadow nodes are based on adjustments to the captured information.

In some systems, the monitoring system may be configured to select between a first shadow node and a first node of the neural network for execution to adjust behavior of the neural network.

In some systems, the monitoring system is configured to automatically generate and deploy the one or more hooks.

In some systems, the monitoring system is configured to select the first shadow node for execution to change the captured information output by the first node of the neural network before receipt by the second node of the neural network.

In some systems, the monitoring system is configured to select the first shadow node for execution to pause subsequent execution across the neural network.

In some systems, the monitoring system is configured to select the first node of the neural network for execution to pass through the captured information to the second node of the neural network.

In some systems, the monitoring system comprises one hook for each connection of the neural network.

Some systems further comprise an interface configured to stream the captured information to an external system.

In some systems, the one or more shadow nodes comprise memory configured to store execution history for pattern-based signal modification.

In some systems, the integration of the monitoring system within the neural network during construction of the neural network establishes cognitive isolation from self-reflective processes of the neural network, such that introspection by the neural network fails to reveal an existence of the monitoring system.

An example monitoring apparatus may be integrated within a neural network during construction of the neural network.

Some apparatuses may comprise one or more hooks configured to access information being exchanged between one or more nodes via one or more connections of the neural network.

Some apparatuses may comprise one or more interceptors configured to capture information being output by a first node of the neural network for receipt by a second node of the neural network.

Some apparatuses may comprise one or more shadow nodes generated to mirror the one or more nodes and the one or more connections of the neural network, wherein the one or more shadow nodes are based on adjustments to the captured information.

Some apparatuses may comprise an interface configured to select between a first shadow node and a first node of the neural network for execution to adjust behavior of the neural network.

Some apparatuses may be configured to automatically generate and deploy the one or more hooks.

In some apparatuses, the interface may be configured to select the first shadow node for execution to change the captured information output by the first node of the neural network before receipt by the second node of the neural network.

In some apparatuses, the interface may be configured to select the first shadow node for execution to pause subsequent execution across the neural network.

In some apparatuses, the interface may be configured to select the first node of the neural network for execution to pass through the captured information to the second node of the neural network.

In some apparatuses, the one or more hooks may correspond to the one or more connections of the neural network in a one-to-one correspondence.

In some apparatuses, the interface may be further configured to stream the captured information to an external system.

An example method may comprise deploying, during construction of a neural network, one or more hooks to access information exchanged between one or more nodes via one or more connections of a neural network, capturing, via the one or more hooks, information output by a first node of the neural network for receipt by a second node of the neural network, mirroring, based on adjustments to the captured information, the one or more nodes of the neural network to form one or more shadow nodes, and selecting between a first shadow node and a first node of the neural network for execution to adjust behavior of the neural network.

Some methods may comprise automatically generating and deploying the one or more hooks.

Some methods may comprise selecting the first shadow node for execution to change the captured information output by the first node of the neural network before receipt by the second node of the neural network.

Some methods may comprise selecting the first shadow node for execution to pause subsequent execution across the neural network.

Some methods may comprise selecting the first node of the neural network for execution to pass through the captured information to the second node of the neural network.

Some methods may comprise streaming the captured information to an external system.

An computer readable storage medium may store instructions that, when executed, cause performance of any of the above methods.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A system comprising:
a neural network comprising one or more nodes and one or more connections; and
a monitoring system that was integrated within the neural network during construction of the neural network, wherein the monitoring system comprises:
one or more hooks to access information being exchanged between the one or more nodes via the one or more connections;
one or more interceptors to capture information being output by a first node of the neural network for receipt by a second node of the neural network; and
one or more shadow nodes generated to mirror the one or more nodes and the one or more connections of the neural network, wherein the one or more shadow nodes are based on adjustments to the captured information,
wherein the monitoring system is to select between a first shadow node and a first node of the neural network for execution to adjust behavior of the neural network.

2. The system of claim 1, wherein the monitoring system is to automatically generate and deploy the one or more hooks.

3. The system of claim 1, wherein the monitoring system is to select the first shadow node for execution to change the captured information output by the first node of the neural network before receipt by the second node of the neural network.

4. The system of claim 1, wherein the monitoring system is to select the first shadow node for execution to pause subsequent execution across the neural network.

5. The system of claim 1, wherein the monitoring system is to select the first node of the neural network for execution to pass through the captured information to the second node of the neural network.

6. The system of claim 1, wherein the monitoring system comprises one hook for each connection of the neural network.

7. The system of claim 1, further comprising an interface to stream the captured information to an external system.

8. The system of claim 1, wherein the one or more shadow nodes comprise memory to store execution history for pattern-based signal modification.

9. The system of claim 1, wherein the integration of the monitoring system within the neural network during construction of the neural network establishes cognitive isolation from self-reflective processes of the neural network, such that introspection by the neural network fails to reveal an existence of the monitoring system.

10. A monitoring apparatus integrated within a neural network during construction of the neural network, the monitoring apparatus comprising:
one or more hooks to access information being exchanged between one or more nodes via one or more connections of the neural network;
one or more interceptors to capture information being output by a first node of the neural network for receipt by a second node of the neural network;
one or more shadow nodes generated to mirror the one or more nodes and the one or more connections of the neural network, wherein the one or more shadow nodes are based on adjustments to the captured information; and
an interface to select between a first shadow node and a first node of the neural network for execution to adjust behavior of the neural network.

11. The apparatus of claim 10, wherein the monitoring apparatus is to automatically generate and deploy the one or more hooks.

12. The apparatus of claim 10, wherein the interface is to select the first shadow node for execution to change the captured information output by the first node of the neural network before receipt by the second node of the neural network.

13. The apparatus of claim 10, wherein the interface is to select the first shadow node for execution to pause subsequent execution across the neural network.

14. The apparatus of claim 10, wherein the interface is to select the first node of the neural network for execution to pass through the captured information to the second node of the neural network.

15. The apparatus of claim 10, wherein the one or more hooks correspond to the one or more connections of the neural network in a one-to-one correspondence.

16. The apparatus of claim 10, wherein the interface is further to stream the captured information to an external system.

17. A computer readable storage medium storing instructions that, when executed, cause:
deploying, during construction of a neural network, one or more hooks to access information exchanged between one or more nodes via one or more connections of a neural network;
capturing, via the one or more hooks, information output by a first node of the neural network for receipt by a second node of the neural network;
mirroring, based on adjustments to the captured information, the one or more nodes of the neural network to form one or more shadow nodes; and
selecting between a first shadow node and a first node of the neural network for execution to adjust behavior of the neural network.

18. The storage medium of claim 17, wherein the instructions, when executed, further cause automatically generating and deploying the one or more hooks.

19. The storage medium of claim 17, wherein the instructions, when executed, further cause selecting the first shadow node for execution to change the captured information output by the first node of the neural network before receipt by the second node of the neural network.

20. The storage medium of claim 17, wherein the instructions, when executed, further cause selecting the first shadow node for execution to pause subsequent execution across the neural network.

21. The storage medium of claim 17, wherein the instructions, when executed, further cause selecting the first node of the neural network for execution to pass through the captured information to the second node of the neural network.

22. The storage medium of claim 17, wherein the instructions, when executed, further cause streaming the captured information to an external system.
